(19) United States
(12) Patent Application Publication
(10) Pub. No.: US 2017/0221105 A1
(43) Pub. Date: Aug. 3, 2017

(54) ONLINE ARTICLE HEADLINE GENERATION

(71) Applicant: International Business Machines Corporation, Armonk, NY (US)

(72) Inventors: John P. Bufe, III, Somerville, MA (US); Donna K. Byron, Petersham, MA (US); Patrick A. Wagstrom, Coventry, CT (US); Timothy P. Winkler, Clinton, MA (US)

(21) Appl. No.: 15/011,821

(22) Filed: Feb. 1, 2016

(51) Int. Cl. G06Q 30/02; H04L 29/08

(52) U.S. Cl. CPC G06Q 30/0263; H04L 67/02; H04L 67/30

(57) ABSTRACT

A computer-implemented method includes identifying an electronically accessible article. A prospective access profile includes context information. The computer-implemented method further includes identifying, based on the context information, a target headline score range. The computer-implemented method further includes extracting an entity relationship graph from the article, identifying core entities, defining a subgraph, and expanding the subgraph by adding related entities, and selecting a headline template based on the subgraph. The computer-implemented method further includes filling the headline template to yield a headline, based on transforming at least one entity of the subgraph to place the headline within the target headline score range. The computer-implemented method further includes presenting the headline to the prospective access profile, monitoring access to the article to yield an access result, and feeding back information to the said prospective access profile. A corresponding computer program product and computer system are also disclosed.

### BACKGROUND

The present invention relates generally to the field of online advertising, and more particularly to dynamically generating headlines for online articles.

Internet-delivered articles and, more generally, online media content are typically presented to users because the publisher has an interest in Internet users consuming such media content. For example, a publisher may rely on revenue from advertising in and around the article or other media content. Alternatively, the publisher may have a social, political, or economic agenda that it hopes to advance by disseminating the article or other media content to a wide audience. To attract readers/viewers/consumers, the publisher may publish a headline in conjunction with a link to the article or other media content on remote websites or other systems with the aim of convincing users to navigate to and consume the article or other media content. Preparers of such headlines continue to face challenges in attracting users to navigate to and consume articles and media content.

### SUMMARY

A computer-implemented method includes identifying an article. The article is electronically accessible by a prospective access profile. The article includes a plurality of words. The access profile includes context information. The computer-implemented method further includes identifying, based on the context information, a target headline score range in at least one score dimension, and extracting, from the article, an entity relationship graph based on the plurality of words. The entity relationship graph includes a plurality of entities and a plurality of relationships among the plurality of entities. The computer-implemented method further includes identifying, from the plurality of entities, one or more core entities, and defining a subgraph. The subgraph initially includes the one or more core entities and those of the plurality of relationships that are among the one or more core entities. The computer-implemented method further includes expanding the subgraph by adding those of the plurality of entities that are connected to any of the one or more core entities by a number of the plurality of relationships that is less than an expansion degree, and selecting a headline template from a headline template library, based on the subgraph. The computer-implemented method further includes filling said headline template to yield a headline, based on transforming at least one entity of the subgraph, such that the headline has a headline score within the target headline score range in the at least one score dimension. The computer-implemented method further includes presenting the headline to the prospective access profile together with a link to the article, monitoring access to the article by the prospective access profile to yield an access result, and feeding back the headline score and the access result for said prospective access profile. A corresponding computer program product and computer system are also disclosed.

### BRIEF DESCRIPTION OF THE DRAWINGS

FIG. 1 is a block diagram depicting a computing environment suitable for operation of a headline generation program, in accordance with at least one embodiment of the present invention.

FIG. 2 is a data flow diagram for a headline generation program, in accordance with at least one embodiment of the present invention.

FIG. 3 is a flowchart diagram for a headline generation program, in accordance with at least one embodiment of the present invention.

FIG. 4 is a block diagram depicting various logical elements for a computer system capable of executing program instructions, in accordance with at least one embodiment of the present invention.

### DETAILED DESCRIPTION

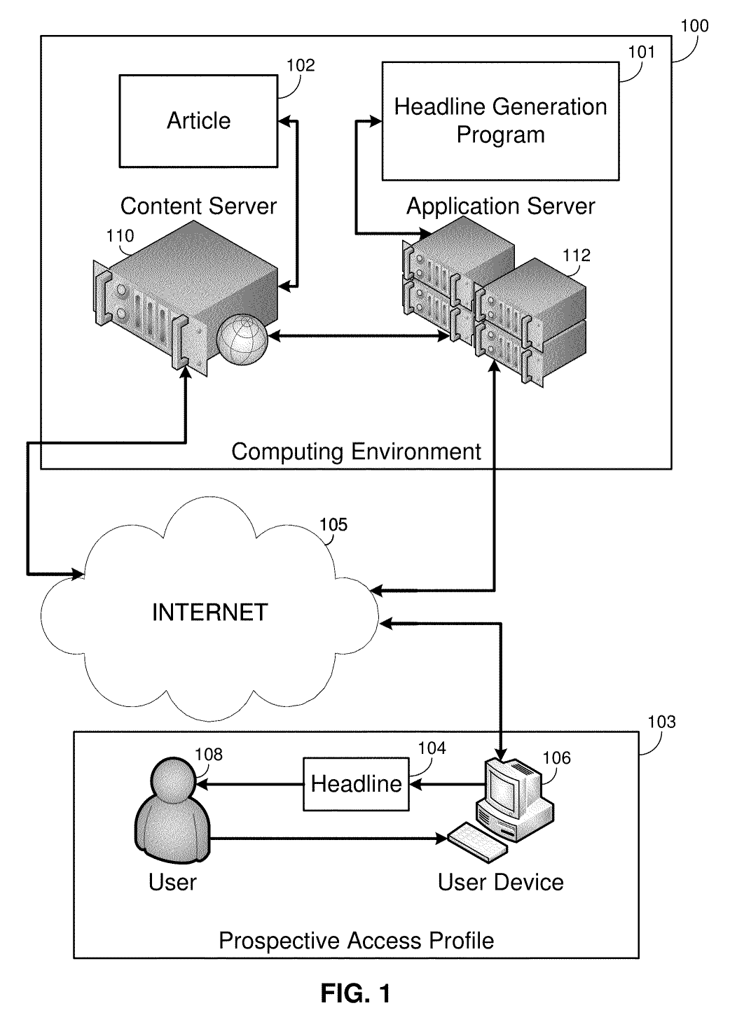

FIG. 1 depicts one possible operating environment for a headline generation program 101, in accordance with at least one embodiment of the present invention. The headline generation program operates within a computing environment 100. In some embodiments, the computing environment 100 may be a network-based configuration of servers, such as a content server 110 and an application server 112. In alternative embodiments, the computing environment 100 may include a cloud-based environment or a single general purpose computer. In the depicted embodiment, an article 102 may be served up over the Internet 105 or other data network to a user 108, who may access the article 102, for example over the World Wide Web, by clicking link associated with a headline 104, which may be generated and presented by the headline generation program 101.

The article 102, generally, may include text and images, or it may include audio or video content. The user 108, together with a user device 106, which may be a personal desktop or laptop computer, mobile phone, tablet, etc., form a prospective access profile 103. The computing environment 100 may include facilities to track and store data relating to each individual prospective access profile 103.

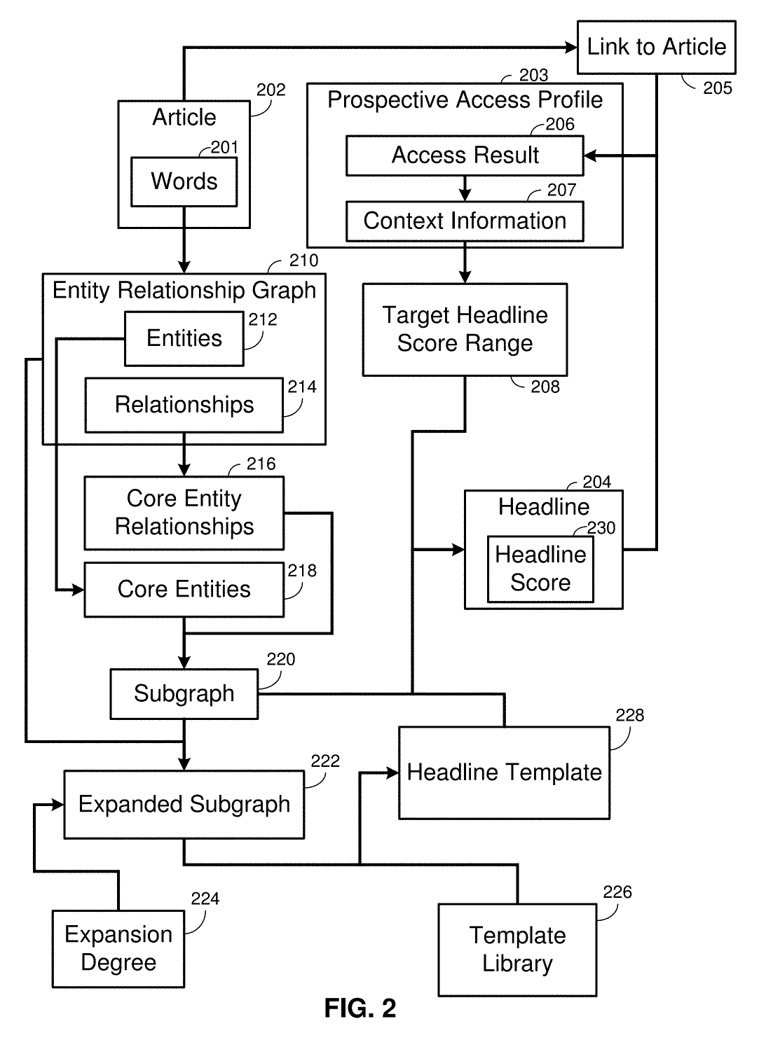

FIG. 2 presents a data flow diagram for a headline generation program 101, in accordance with at least one embodiment of the present invention. An article 202 may be electronically accessible by a prospective access profile 203. As depicted, the article 202 includes a plurality of words 201. The article 202 may include text content as well as images, audio, or video content, or other multimedia content. The words 201 may be in any human language, including both written and spoken forms, which may be extracted from the textual, audio, video, or other multimedia data of the article 202.

Referring still to FIG. 2, the prospective access profile 203 may include context information 207. Context information 207 for a given prospective access profile 203 may include Internet navigation behavior, purchase behavior, media content preferences, geolocation data, or other information relevant to marketing. The context information 207 may be enriched by logging an access result 206 when a headline 204 is presented to the prospective access profile 203 with a link 205 to the article 202. The access result 206 may be understood as the result of monitoring, by the headline generation program 101, whether the prospective access profile 203 accesses the article 202 via the headline 204 and, optionally, other characteristics such as how long the prospective access profile 203 spends viewing and/or playing back the article 202. The headline generation program 101 may be understood to feed back the access result 206 and headline 204 (together with the headline score 230) to the prospective access profile 203.

Referring still to FIG. 2, the headline generation program may extract an entity relationship graph 210 from the words 201 of the article 202. The entity relationship graph 210 may present various entities 212—objects discussed or described in the article 202—and the relationships 214 among the entities 212, based on syntactical analysis of the words 201. The entity extraction may be achieved by IBM® Statistical Information and Relation Extraction (“SIRE”) software. In general, the entity extraction may be achieved by a program or module that detects mentions (mention detection) in the text to entities of interest (e.g. Person, Organization, Medication, etc.), groups all mentions that refer to the same entity in the world together (co-reference resolution), and extracts relations between the detected entities from the text (relation extraction). In various embodiment, the entities 212 may be represented as labels with no associated rich data, though in alternative embodiments, the entities 212 may include key/value or key/data pairs. In various embodiments, the relationships 214 may be represented as an edge in the entity relationship graph 210 with each relationship optionally having a weight associated therewith. The headline generation program 101 may employ weighting thresholds to determine the desired level of expansion and/or branching of the entity relationship graph 210. In generating the entity relationship graph 210, the headline generation program 101 may employ such techniques as topic modelling, mention counts, and focusing devices.

The headline generation program 101 may identify various core entities 218 and the core entity relationships 216 among them from the entities 212 and relationships, respectively. The selection of core entities 218 may be based on the weights and/or other techniques described above. The resulting core entities 218 may be understood as those that the article 202 is fundamentally about. From the core entities 218, the headline generation program may define a subgraph 220, which initially includes the core entities, but which may be expanded into an expanded subgraph 222 by adding entities 212 that are connected to the core entities 218 by less than an expansion degree 224. The expansion degree 224 may be predetermined at design time or may be adaptively determined based on the weights of the relationships 214, context information 207, or other factors. For example, if the expansion degree 224 is one, then all entities 212 that are directly related to one of the core entities 218 may be added to the subgraph 220. If the expansion degree 224 is two, then all entities 212 that are related by two steps or one step to one of the core entities 218 may be added to the subgraph 220.

The headline generation program 101 may filter the subgraph 220 (with or without expansion into the expanded subgraph 222) by removing at least one entity 212 from the subgraph 220, based on at least one of the prospective access profile 203 or the entity relationship graph 210. Filtering may include removing information that is extraneous, with extraneous information identified by comparison of the entity relationship graph 210 with background corpora to determine what information may be general knowledge or not of insight specific to the article 202. Background information may also be identified by implication or clustering of concepts that are usually related, for example the labels “Rio” and “Brazil” may be considered implied by or clustered with the label “2016 Olympics”. Further, extraneous information may be identified by comparison with context information 207 from the prospective access profile 203, for example to determine what is not of personal interest to the user associated with the prospective access profile 203.

The headline generation program 101 may select a headline template 228 from headline template library 226 based on the subgraph 220 (or, the expanded subgraph 222). The headline generation program 101 may fill the headline template 228 to yield a headline 204, based on transforming entities 212 from the subgraph 220 (or, the expanded subgraph 222). Transforming at least one entity 212 of the subgraph 220 may include underspecifying at least one entity 212 of the subgraph 220. Underspecifying an entity 212 may include generalizing or obfuscating the entity 212. For example, the label “Putin” may be underspecified as “world leader”, or the label “Jordan” may be underspecified as “sports star”. Depending upon the headline template 228, underspecifying may include words that tailor the excitement, surprise, novelty, or hype of the headline, for example converting the name of a person into “you will never believe who”.

The headline generation program 101 may score headlines 204 in various score dimensions. The score dimensions may include at least one headline property selected from the group consisting of: (a) length; (b) directedness; (c) sensationalism; (d) surprisingness; (e) fraction of content that is extraneous; (f) fraction of content that is informational; and (g) recentness. The headline generation program 101 may generate a target headline score range 208, based on the context information 207 for the prospective access profile 203. Specifically, the headline generation program 101 may identify a target score range based on the prospective access profile 203's history of responding to headlines that are scored in various ways.

Where at least one headline property includes length, length of the headline may be measured directly in words, characters, or units of data. Where at least one headline property includes recentness, the headline generation program 101 may score recentness directly by comparing the current time when presenting the headline 204 to the date or time of the article 202.

Where at least one headline property includes directedness, the headline generation program 101 may score directedness by an extent to which a scored headline comprises words or phrases that address the prospective access profile. Directed phrases may include such statements as “you will never believe . . . ” or “you can lose weight by . . .”. Where at least one headline property includes sensationalism, the headline generation program 101 may score sensationalism by an extent to which a scored headline includes words or phrases of excitement. Examples of words or phrases of excitement include “amazing”, or “unbelievable”. Where at least one headline property includes surprisingness, the headline generation program 101 may score surprisingness by an extent to which a scored headline comprises words or phrases that suggest that at least some hidden information is revealed in the article 202. Examples of words or phrases that suggest that hidden information is revealed include “did you know?”, “this one neat trick”, or “you will never guess”.

Where at least one headline property includes the fraction of content that is extraneous, the headline generation program 101 may score extraneousness similarly to filtering the entity relationship graph 210, as described above. For example, the headline, “Obama meets Putin in US-Russia Talks” may be scored as extraneous because the entities “US” and “Russia” are redundant after introducing “Obama” and “Putin”. Similarly, where at least one headline property includes the fraction of content that is informational, the headline generation program 101 may score informationality similarly to leaving content in when filtering the entity relationship graph 210, as described above. For example, the headline “Jeff Bezos' Blue Origin Successfully Demonstrates Re-Use of New Shepherd Rocket” may be scored as high in its fraction of information, while “This One Neat Trick Will Help You Lose Weight” may be scored as low in information.

The headline generation program 101 may select and fill the headline template 228 so as to place the headline score 230 within the target headline score range 208. Both the headline score 230 and the target headline score range 208 may be on any score dimension or combination of score dimensions.

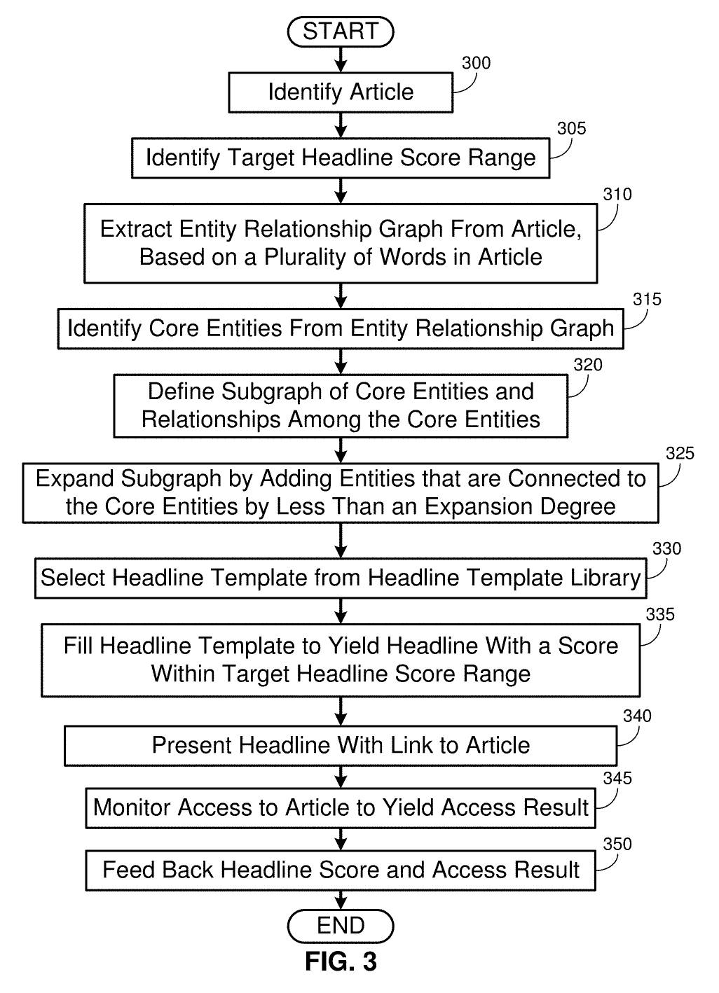

FIG. 3 displays a flowchart diagram for the headline generation program 101, in accordance with at least one embodiment of the invention. At step 300, the headline generation program 101 identifies an article 202. The article 202 is electronically accessible by a prospective access profile 203. The article 202 includes a plurality of words. The prospective access profile 203 includes context information 207. At step 305, the headline generation program 101 identifies, based on the context information 207, a target headline score range 208 in at least one score dimension. At step 310, extracting, from the article 202, an entity relationship graph 210, based on the plurality of words 201, the entity relationship graph 210 includes a plurality of entities 212 and a plurality of relationships 214 among the plurality of entities 212. At step 315, the headline generation program 101 may identify, from the plurality of entities 212, one or more core entities 218.

At step 320, the headline generation program 101 defines a subgraph 220. The subgraph 220 initially includes the one or more core entities 218 and those of the plurality of relationships 214 that are among the one or more core entities 218. The subgraph may be represented as a separate data structure to the entity relationship graph 210, or within the same data structure by flagging or associating entities 212 as within the subgraph 220. At step 325, the headline generation program 101 may expand the subgraph 220 by adding those of the plurality of entities 212 that are connected to any of the one or more core entities 218 by a number of the plurality of relationships 214 that is less than an expansion degree 224. The expansion step may yield an expanded subgraph 222 or the expansion may be represented within the same data structure as the subgraph 220.

Referring still to FIG. 3, at step 330, the headline generation program 101 selects a headline template 228 from a headline template library 226, based on the subgraph 220. Specifically, the headline generation program 101 may select a template that grammatically fits the entities 212 of the subgraph 220 and that tends toward headlines within the target headline score range 208. At step 335, the headline generation program 101 fills the headline template 228 to yield a headline 204, based on transforming at least one entity 212 of the subgraph 220, such that the headline 204 has a headline score 230 within the target headline score range 208 in the at least one score dimension. Specifically, transforming at least one entity 212 may include obfuscating or underspecifying entities 212 and adding/dropping extraneous information to place the headline score 230 in the target headline score range 208.

At step 340, the headline generation program 101 presents the headline 204 to the prospective access profile 203 together with a link 205 to the article 202. Presentation of the link 205 and headline 204 may be directed to the user 108 via the user device 106. At step 345, the headline generation program 101 monitors access to the article 202 by the prospective access profile 203 to yield an access result 206. The access result 206 may include whether or not the user 108 clicks or otherwise accesses the link 205 in response to the headline 204, optionally within a predetermined period of time. The access result 206 may also include various metrics as to whether the user 108 has actually consumed the article 202, for example if the user 108 has spent sufficient time accessing the article 202 to have read, watched, and/or listened to the article 202 or a sufficient portion thereof.

At step 350, the headline generation program 101 feeds back the headline score 230 and the access result 206 for the prospective access profile 203. Feeding back may include storing the access result 206, headline score 230, and related data in the context information 207.

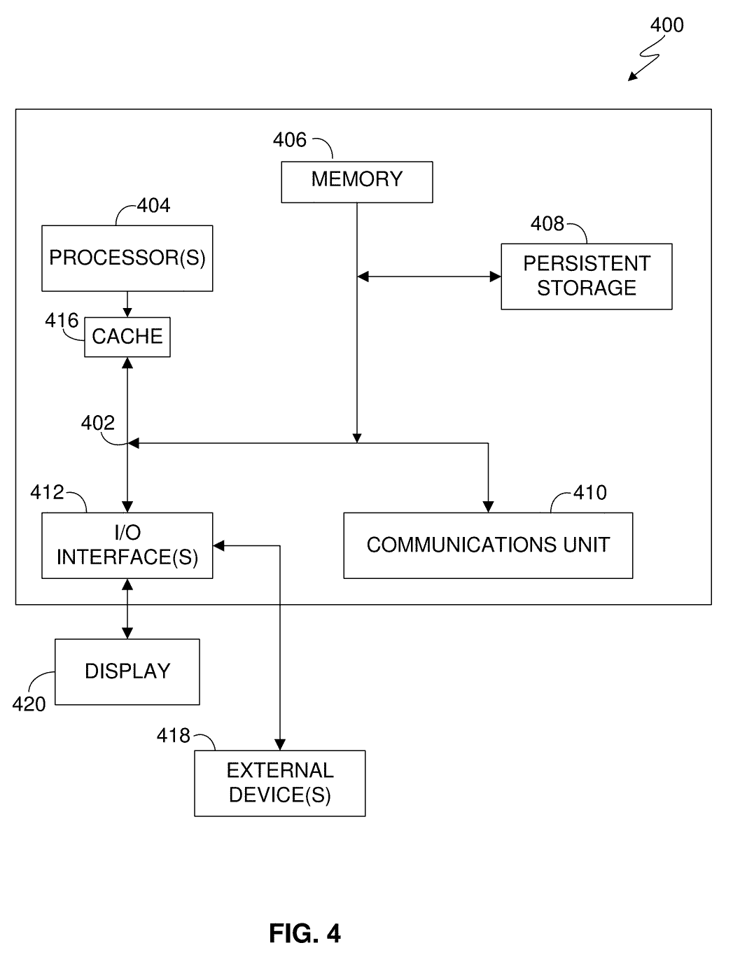

FIG. 4 is a block diagram depicting components of a computer 400 suitable for executing the headline generation program 101. FIG. 4 displays the computer 400, the one or more processor(s) 404 (including one or more computer processors), the communications fabric 402, the memory 406, the RAM, the cache 416, the persistent storage 408, the communications unit 410, the I/O interfaces 412, the display 420, and the external devices 418. It should be appreciated that FIG. 4 provides only an illustration of one embodiment and does not imply any limitations with regard to the environments in which different embodiments may be implemented. Many modifications to the depicted environment may be made.

As depicted, the computer 400 operates over a communications fabric 402, which provides communications between the cache 416, the computer processor(s) 404, the memory 406, the persistent storage 408, the communications unit 410, and the input/output (I/O) interface(s) 412. The communications fabric 402 may be implemented with any architecture suitable for passing data and/or control information between the processors 404 (e.g., microprocessors, communications processors, and network processors, etc.), the memory 406, the external devices 418, and any other hardware components within a system. For example, the communications fabric 402 may be implemented with one or more buses or a crossbar switch.

The memory 406 and persistent storage 408 are computer readable storage media. In the depicted embodiment, the memory 406 includes a random access memory (RAM). In general, the memory 406 may include any suitable volatile or non-volatile implementations of one or more computer readable storage media. The cache 416 is a fast memory that enhances the performance of computer processor(s) 404 by holding recently accessed data, and data near accessed data, from memory 406.

Program instructions for the headline generation program 101 may be stored in the persistent storage 408 or in memory 406, or more generally, any computer readable storage media, for execution by one or more of the respective computer processors 404 via the cache 416. The persistent storage 408 may include a magnetic hard disk drive. Alternatively, or in addition to a magnetic hard disk drive, the persistent storage 408 may include, a solid state hard disk drive, a semiconductor storage device, read-only memory (ROM), electronically erasable programmable read-only memory (EEPROM), flash memory, or any other computer readable storage media that is capable of storing program instructions or digital information.

The media used by the persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of the persistent storage 408.

The communications unit 410, in these examples, provides for communications with other data processing systems or devices. In these examples, the communications unit 410 may include one or more network interface cards. The communications unit 410 may provide communications through the use of either or both physical and wireless communications links. The headline generation program 101 may be downloaded to the persistent storage 408 through the communications unit 410. In the context of some embodiments of the present invention, the source of the various input data may be physically remote to the computer 400 such that the input data may be received and the output similarly transmitted via the communications unit 410.

The I/O interface(s) 412 allows for input and output of data with other devices that may operate in conjunction with the computer 400. For example, the I/O interface 412 may provide a connection to the external devices 418, which may include a keyboard, keypad, a touch screen, and/or some other suitable input devices. External devices 418 may also include portable computer readable storage media, for example, thumb drives, portable optical or magnetic disks, and memory cards. Software and data used to practice embodiments of the present invention may be stored on such portable computer readable storage media and may be loaded onto the persistent storage 408 via the I/O interface(s) 412. The I/O interface(s) 412 may similarly connect to a display 420. The display 420 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method comprising:
identifying an article, said article being electronically accessible by a prospective access profile, said article comprising a plurality of words, said prospective access profile comprising context information;
identifying, based on said context information, a target headline score range in at least one score dimension;
extracting, from said article, an entity relationship graph based on said plurality of words, said entity relationship graph comprising a plurality of entities and a plurality of relationships among said plurality of entities;
identifying, from said plurality of entities, one or more core entities;
defining a subgraph, said subgraph initially comprising said one or more core entities and those of said plurality of relationships that are among said one or more core entities;
expanding said subgraph by adding those of said plurality of entities that are connected to any of said one or more core entities by a number of said plurality of relationships that is less than an expansion degree;
selecting a headline template from a headline template library, based on said subgraph;
filling said headline template to yield a headline, based on transforming at least one entity of said subgraph, such that said headline has a headline score within said target headline score range in said at least one score dimension;
presenting said headline to said prospective access profile together with a link to said article;
monitoring access to said article by said prospective access profile to yield an access result; and
feeding back said headline score and said access result for said prospective access profile.

2. The computer-implemented method of claim 1, wherein transforming at least one entity of said subgraph comprises underspecifying said at least one entity of said subgraph.

3. The computer-implemented method of claim 1, further comprising filtering said subgraph by removing at least one entity from said subgraph, based on at least one of said prospective access profile or said entity relationship graph.

4. The computer-implemented method of claim 1, wherein said at least one score dimension comprises at least one headline property selected from the group consisting of:
(a) length;
(b) directedness;
(c) sensationalism;
(d) surprisingness;
(e) fraction of content that is extraneous;
(f) fraction of content that is informational; and
(g) recentness.

5. The computer-implemented method of claim 4:
wherein said at least one headline property comprises directedness; and
further comprising scoring directedness by an extent to which a scored headline comprises words or phrases that address said prospective access profile.

6. The computer-implemented method of claim 4:
wherein said at least one headline property comprises surprisingness; and
further comprising scoring surprisingness by an extent to which a scored headline comprises words or phrases that suggest that at least some hidden information is revealed in said article.

7. The computer-implemented method of claim 4:
wherein said at least one headline property comprises sensationalism; and
further comprising scoring sensationalism by an extent to which a scored headline comprises words or phrases of excitement.

8. A computer program product comprising one or more computer readable storage media and program instructions stored on said one or more computer readable storage media, said program instructions comprising instructions to:
identify an article, said article being electronically accessible by a prospective access profile, said article comprising a plurality of words, said prospective access profile comprising context information;
identify, based on said context information, a target headline score range in at least one score dimension;
extract, from said article, an entity relationship graph based on said plurality of words, said entity relationship graph comprising a plurality of entities and a plurality of relationships among said plurality of entities;
identify, from said plurality of entities, one or more core entities;
define a subgraph, said subgraph initially comprising said one or more core entities and those of said plurality of relationships that are among said one or more core entities;
expand said subgraph by adding those of said plurality of entities that are connected to any of said one or more core entities by a number of said plurality of relationships that is less than an expansion degree;
select a headline template from a headline template library, based on said subgraph;
fill said headline template to yield a headline, based on transforming at least one entity of said subgraph, such that said headline has a headline score within said target headline score range in said at least one score dimension;
present said headline to said prospective access profile together with a link to said article;
monitor access to said article by said prospective access profile to yield an access result; and
feed back said headline score and said access result for said prospective access profile.

9. The computer program product of claim 8, wherein said instructions to transform at least one entity of said subgraph comprise instructions to underspecify said at least one entity of said subgraph.

10. The computer program product of claim 8, wherein said program instructions further comprise instructions to filter said subgraph by removing at least one entity from said subgraph, based on at least one of said prospective access profile or said entity relationship graph.

11. The computer program product of claim 8, wherein said at least one score dimension comprises at least one headline property selected from the group consisting of:
(a) length;
(b) directedness;
(c) sensationalism;
(d) surprisingness;
(e) fraction of content that is extraneous;
(f) fraction of content that is informational; and
(g) recentness.

12. The computer program product of claim 11, wherein:
said at least one headline property comprises directedness; and
said program instructions further comprise instructions to score directedness by an extent to which a scored headline comprises words or phrases that address said prospective access profile.

13. The computer program product of claim 11, wherein:
said at least one headline property comprises surprisingness; and
said program instructions further comprise instructions to score surprisingness by an extent to which a scored headline comprises words or phrases that suggest that at least some hidden information is revealed in said article.

14. The computer program product of claim 11, wherein:
said at least one headline property comprises sensationalism; and
said program instructions further comprise instructions to score sensationalism by an extent to which a scored headline comprises words or phrases of excitement.

15. A computer system comprising:
one or more processors;
one or more computer readable storage media;
computer program instructions;
said computer program instructions being stored on said one or more computer readable storage media;
said computer program instructions comprising instructions to:
identify an article, said article being electronically accessible by a prospective access profile, said article comprising a plurality of words, said prospective access profile comprising context information;
identify, based on said context information, a target headline score range in at least one score dimension;
extract, from said article, an entity relationship graph based on said plurality of words, said entity relationship graph comprising a plurality of entities and a plurality of relationships among said plurality of entities;
identify, from said plurality of entities, one or more core entities;
define a subgraph, said subgraph initially comprising said one or more core entities and those of said plurality of relationships that are among said one or more core entities;
expand said subgraph by adding those of said plurality of entities that are connected to any of said one or more core entities by a number of said plurality of relationships that is less than an expansion degree;
select a headline template from a headline template library, based on said subgraph;
fill said headline template to yield a headline, based on transforming at least one entity of said subgraph, such that said headline has a headline score within said target headline score range in said at least one score dimension;
present said headline to said prospective access profile together with a link to said article;
monitor access to said article by said prospective access profile to yield an access result; and
feed back said headline score and said access result for said prospective access profile.

16. The computer system of claim 15, wherein said instructions to transform at least one entity of said subgraph comprise instructions to underspecify said at least one entity of said subgraph.

17. The computer system of claim 15, wherein said computer program instructions further comprise instructions to filter said subgraph by removing at least one entity from said subgraph, based on at least one of said prospective access profile or said entity relationship graph.

18. The computer system of claim 15, wherein said at least one score dimension comprises at least one headline property selected from the group consisting of:
(a) length;
(b) directedness;
(c) sensationalism;
(d) surprisingness;
(e) fraction of content that is extraneous;
(f) fraction of content that is informational; and
(g) recentness.

19. The computer system of claim 18, wherein:
said at least one headline property comprises directedness; and
said computer program instructions further comprise instructions to score directedness by an extent to which a scored headline comprises words or phrases that address said prospective access profile.

20. The computer system of claim 18, wherein:
said at least one headline property comprises surprisingness; and
said program instructions further comprise instructions to score surprisingness by an extent to which a scored headline comprises words or phrases that suggest that at least some hidden information is revealed in said article.
